(19) United States
(12) Patent Application Publication
(10) Pub. No.: US 2026/0162460 A1
(43) Pub. Date: Jun. 11, 2026

(54) 3D PRINTED OBJECT DIGITAL EXTENSION USING VIDEO

(71) Applicant: INTERNATIONAL BUSINESS MACHINES CORPORATION, Armonk, NY (US)

(72) Inventors: Zachary Augustus Silverstein, Georgetown, TX (US); Logan Bailey, Atlanta, GA (US); Wesley Ip, Arlington, TX (US); Alexandra M Isaly, Austin, TX (US)

(21) Appl. No.: 18/969,921

(22) Filed: Dec. 5, 2024

(51) Int. Cl. G06V 40/20; G06F 3/023; G06V 10/70; G06V 20/64

(52) U.S. Cl. CPC G06V 40/20; G06V 10/70; G06V 20/64; G06F 3/023

(57) ABSTRACT

A computer-implemented method includes capturing, using one or more cameras, user interactions with a printed three-dimensional (3D) object. The printed 3D object has a digital twin. The user interactions, captured by the one or more cameras, are interpreted using the digital twin. Actions are generated based on the interpreted user interactions.

### BACKGROUND

The present invention generally relates to three-dimensional (3D) and four-dimensional (4D) printing and, more particularly, to systems and methods that enable 3D printed objects to generate actions using video without instrumentation of 3D printed objects.

Three-dimensional (3D) printing of an object provides a methodology for generating detailed objects, physical pieces, prototypes, etc. However, embedding smart sensors, electrical components, and other instrumentation within a 3D printed object can add significant levels of complexity and expense to printed objects. When an item is 3D printed, for example, a keyboard, the buttons may have a degree of movement or interaction, but embedding circuit boards, electrical components and mechanical switches adds complexity that exceeds the ability of most casual 3D printing users.

### SUMMARY

In accordance with an embodiment of the present invention, a computer-implemented method includes capturing, using one or more cameras, user interactions with a printed three-dimensional (3D) object. The printed 3D object has a digital twin. The user interactions, captured by the one or more cameras, are interpreted using the digital twin. Actions are generated based on the interpreted user interactions.

In accordance with another embodiment of the present invention, a computer system includes a processor set, one or more computer-readable storage media and program instructions stored on the one or more computer-readable storage media to cause the processor set to perform operations. The operations include capturing, using one or more cameras, user interactions with a printed three-dimensional (3D) object. The printed 3D object has a digital twin. The user interactions captured by the one or more cameras are interpreted using the digital twin. Actions are generated based on the interpreted user interactions.

In accordance with another embodiment of the present invention, a computer program product includes one or more computer-readable storage media and program instructions stored on the one or more computer-readable storage media to perform operations. The operation includes capturing, using one or more cameras, user interactions with a printed three-dimensional (3D) object, the printed 3D object having a digital twin; interpreting the user interactions captured by the one or more cameras using the digital twin; and generating actions based on the interpreted user interactions.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block/flow diagram showing a system for digitally extending a 3D printed object without instrumentation, in accordance with an embodiment of the present invention;

FIG. 2 is a block/flow diagram showing an interaction gathering portion of the system for digitally extending a 3D printed object without instrumentation, in accordance with an embodiment of the present invention;

FIG. 3 is a flow diagram showing an interaction and setup of the system for digitally extending a 3D printed object without instrumentation, in accordance with an embodiment of the present invention;

FIG. 4 is a block diagram showing a computer environment for digitally extending a 3D printed object, in accordance with an embodiment of the present invention; and

FIG. 5 is a flow diagram showing methods for digitally extending a 3D printed object, in accordance with an embodiment of the present invention.

### DETAILED DESCRIPTION

In accordance with embodiments of the present invention, systems and methods are described for optimizing 3D printed objects specific to video capture devices. Embodiments of the present invention combine the precision of 3D printing with video capture to replicate instrumented devices without incorporating instrumentation. The precise 3D printed object optimizes degrees of movement and positional information collection to capture interactions between a user and the 3D printed object. The interactions can be captured using one or more cameras. Gestures and interactions captured within the image are submitted for translation into commands or actions. The translations of the interactions with the 3D printed object can employ a digital twin of the 3D object. The interaction can be translated to commands or actions using an action repository, which generates a sequence of actions based upon the translated interactions with the 3D printed object.

In an example, a keyboard can be 3D printed. A user can then type on the keyboard, and the interactions with the keyboard are received as images by a camera system. The images are then interpreted using gesture recognition and a digital twin to interpret which keys are pressed. The keystrokes can be translated into text or commands, which can be executed by a computer system. In this way, the video feeds are leveraged along with a mapped digital twin to remove the need for electrical embedding within the keyboard.

In an embodiment, a computer-implemented method for 3D printed object digital extension includes designing an item to be 3D printed (e.g., using computer aided design tools or can be selected from a corpus of blueprints). The item is then 3D printed in accordance with the blueprints. A digital twin can be generated using the blueprint. An interaction model is trained based upon interactions with the 3D printed object using the digital twin and a camera system to interpret locations and types of interactions with the 3D printed object so that the interactions and their context can be learned by a gesture interpretation program. The interactions can be interpreted as text or commands and can result in an action or actions generated by an execution system. The execution system performs the actions in accordance with the interactions with the 3D printed object and compares them to a ground truth (intended result) until the interaction model is adequately trained.

In another embodiment, an instrumented non-3D printed version of the item can be employed to train the interaction model. The instrumented non-3D printed version of the item can be used to learn user gestures and interactions with real time feedback (e.g., in the form of electrical signals or other means) generated while interacting with the instrumented non-3D printed version of the item. The execution system performs the actions in accordance with the interactions with instrumented non-3D printed version of the item and learns the gestures associated with the interactions until the interaction model is trained.

During operations, user interactions with the 3D printed object are captured using one or more cameras. The interaction model and/or the digital twin are consulted to interpret the motion and precise locations of contact on the 3D printed object during the interactions. The interpreted motion and locations of contact associated with the interactions with the 3D printed object result in output that is equivalent to an item with instrumentation undergoing the same motion and locations of contact. Equivalent actions can also be generated by the execution system. The execution system can dispatch commands at an operating system (OS) level or an application level using appropriate agents within the execution system. While the action can be associated with the equivalent item with instrumentation (e.g., electrical components), the actions can be interpreted differently and can be assigned other tasks and customized in accordance with user preferences. The execution system can include peripherals (other 3D printers) or other machines that can assist in carrying out the actions.

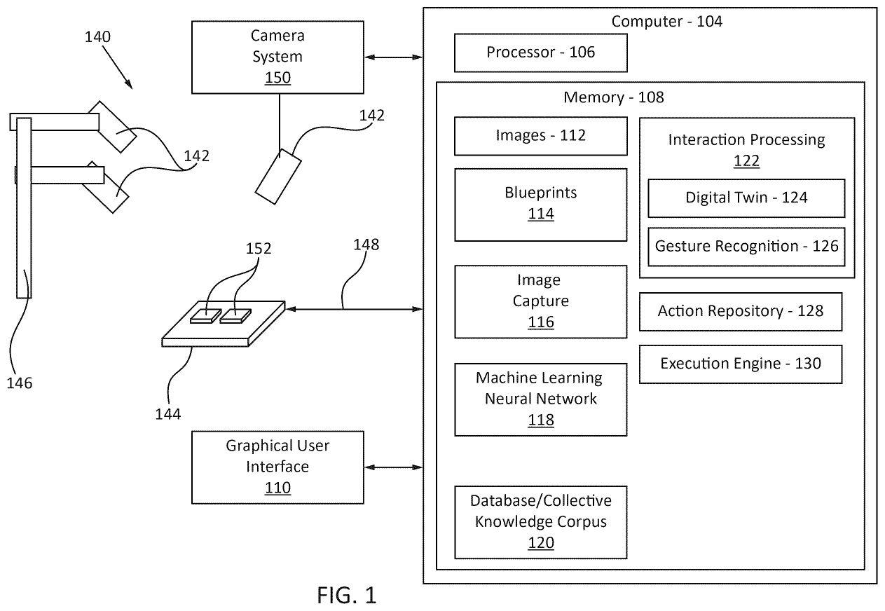

Referring now to the drawings in which like numerals represent the same or similar elements and initially to FIG. 1, a system 100 for mapping interactions with a 3D printed object is shown and described in accordance with embodiments of the present invention. The system 100 includes one or more cameras 142 that can be linked in a camera system 150. The camera system 150 can be connected to a computer system 104. The cameras 142 can be placed at a number of locations and angles to gather data from a plurality of perspectives. The cameras 142 can be mounted on a gantry 146 or other structure or structures that can permit adjustments to the positions of the cameras 142. The cameras 142 can include magnification capabilities, focus settings, aperture settings, etc. and lighting conditions, lighting angles, number of sources, etc., which can be set and adjusted, as needed. These camera settings and lighting settings can be adjusted to ensure proper information gathering.

The system 100 can include the computer system 104, which can include any type of computing device, such as, e.g., a desktop computer, a laptop, a cell phone or any other suitable processing devices that can run software and store data. The computer system 104 includes one or more processors 106 configured to control operations of the system 100 and to run software stored in a memory 108. The memory 108 can include any form of memory including but not limited to a hard drive with solid state memory. A graphical user interface (GUI) 110 and other peripherals can also be employed for interacting with the system 100.

The memory 108 stores program code that runs features in accordance with embodiments of the present invention. The memory 108 also stores data including images 112, blueprints 114 for a 3D model to be printed, etc.

The system 100 employs the cameras 142 to capture images at different angles of an object 144. The object 144 can include a 3D printed object printed by a 3D printer (not shown). In another embodiment, the object 144 can include a non-3D printed object with instrumentation.

A 3D printer includes an additive manufacturing printer that can render a physical object (3D print object 144) with high precision in accordance with blueprints 114. The blueprints 114 include a digital model (computer aided design (CAD) model) of a device or object to be printed.

In accordance with embodiments of the present invention, the 3D print object 144 is printed and can include features 152. The features 152 may or may not be designed to interface with a user or an object (e.g., a tool, a pointer, or the like). Because the 3D print object 144 is rendered from a detailed digital model or the blueprints 114, spatial relationships of the features 152 and the 3D print object 144 in general are accurately known and included in digital form.

Image capture software 116 stored in memory 108 is employed to record interactions between a user and the object 144. Initially, the interactions can be recorded for training of a machine learning neural network 118. The machine learning neural network 118 can be trained by interpreting the interactions with the object 144 and associating the interactions with text or commands which can be issued to carry out corresponding actions. The interpretation of the interactions with the object 144 and association of the interactions with text or commands can be performed using interaction processing software 122. The interaction processing software 122 interacts with image capture software 116, stored in memory 108, which identifies and stores relevant interactions with the object 144. The image capture software 116 records and labels the interactions with the object 144. The interactions can be recorded for training of a machine learning neural network 118.

The interaction processing software 122 can include a digital twin 124 that can by generated from the blueprint 114 to precisely define a coordinate system of the object 144 and its features 152. The interactions, e.g., touching, tapping, dragging, etc. over different locations of the object 144 and features 152 can be digitally mapped using the digital twin 124. In addition, gesture information, fingers used, hand shapes, body positioning, etc. can also be processed using gesture recognition software 126. Using these and other tools, the interactions with the object 144 can be associated with outcomes, e.g., a ground truth, or a desired result of the action. By associating the interactions with an action to be performed, the machine learning neural network 118 can be trained by receiving the labeled interaction footage and associating the gestures and positions relative to the object 144 and its features 152. With the input images being associated with actions or results, the machine learning neural network 118 can predict intended actions from the interactions with the object.

In another embodiment, if the object 144 can include a device that can be instrumented (e.g., a keyboard), then the object 144 with instrumentation can be employed to more rapidly train the machine learning neural network 118. For example, an instrumented keyboard and be employed to image keystrokes (e.g., interactions with the object 144). The object 144 can be connected directly to the computer system 104 using a connection 148 (wired or wireless). Keystrokes made by hitting keys (e.g., features 152) would be known to the computer system 104 and can be associated with camera footage captured by the camera system 150. The keystroke signals and the images 112 can be employed to train the machine learning neural network 118.

After training is complete, the system 100 can be employed to implement functionality on 3D printed objects that are not instrumented or are only partially instrumented. The object 144 with features 152 can be printed and presented for recording interactions with the object 144 and features 152. The object 144 is placed in view of the camera system 150 and adjustments can be made to the cameras 142 to ensure that relevant interactions can be recorded.

Once the system 100 is initiated, a user can begin interacting with the object 144 and its features 152 to input data, text or commands to the computer system 104. The images 112 are input from the camera system 150 and the image capture software 116 determines relevant interactions. The interactions with the object 144 are interpreted using the interaction processing software 122. The interaction processing software 122 can employ the digital twin 124 and gesture recognition software 126 to interpret the meaning of the interactions with the object 144 and its features 152. The interpretation of the interactions can optionally be optimized using the machine learning neural network 118.

Once the interactions are interpreted, the interactions are associated with actions. In an embodiment, the interactions can correspond to text being generated (e.g., if the object 144 is a keyboard). In another embodiment, the interactions can correspond to whole words being generated. In another embodiment, the interactions can correspond to commands being generated. An action repository 128 can store a plurality of possible actions (generation of text, words, sentences, symbols, commands, sounds, lights, etc.) and methods to carry out these actions. In an embodiment, the action repository 128 can include computer commands that can be executed by an execution engine 130 (execution system). For example, hitting a particular feature 152 on the object 144 may issue a print command. In another example, the object can be a 3D printed map or globe and touching a region or country can cause the execution engine 130 to render an image of that country and supporting text on the GUI 110. In another example, the computer system 104 can include a speaker connection and musical notes can be rendered upon contact with piano keys.

The execution engine 130 can be employed and an interface to execute special instructions, which may not be otherwise understood by the computer system 104. However, the computer system 104 can be modified or trained to execute these actions. In such a case, the execution engine 130 can be optional.

The object 144 is mapped to the digital twin, which is or is derived from the digital blueprints of the object 144. A high-fidelity camera space can include cameras of the camera system 150 that are located at different locations including cameras that are remotely disposed (different rooms, locations, countries, etc.). If lower quality cameras are employed, 3D printed objects 144 can have more pronounced or emphasized or detectable features 164 to enable additional clarity despite the lower quality images.

The cameras 142 can monitor other users in multiple locations. The camera system 150 can monitor different users on a same device (object 144), e.g., two users playing a four-handed piano piece, or different devices (object 144) that are remotely disposed, e.g., two remote users each having a 3D printed object 144 printed from the same blueprint and their activities combined to output actions, for example, two users playing a four-handed piano piece remotely from each other.

The neural networks 118 include a system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples, can be formatted as a string of values and fed into the input of the neural network. Each example may be associated with a known result or output. Examples can include solid-state batteries having particular failure modes being associated with countermeasures, shock and vibration response features associated with countermeasures, etc. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, a trained neural network 162 can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer of source nodes, and a single computation layer having one or more computation nodes that also act as output nodes, where there is a single computation node for each possible category into which the input example could be classified. An input layer can have a number of source nodes equal to the number of data values in the input data. The data values in the input data can be represented as a column vector. Each computation node in the computation layer generates a linear combination of weighted values from the input data fed into nodes of the input layer and applies a non-linear activation function that is differentiable to the sum. The exemplary simple neural network can perform classification on linearly separable examples (e.g., patterns).

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer and applies a non-linear activation function that is differentiable over the range of the linear combination. The weights applied to the value from each previous node can be denoted, for example, by w₁, w₂, . . . w_{n-1,} wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

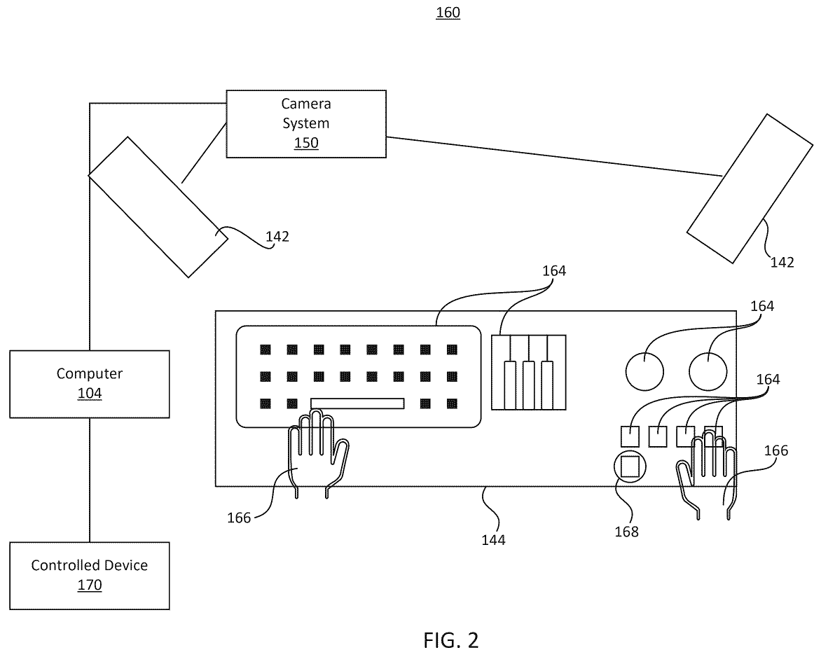

Referring to FIG. 2 with continued reference to FIG. 1, a diagram depicts a system 160 for 3D printing the 3D printed object 144 (a mapped artifact) to be used in a high fidelity camera space and monitor visual interactions with the mapped artifact. The 3D printed object 144 is functional as a mapped object that includes one or more features 164 that employ their shape (and/or other characteristics) and location on the 3D printed object 144 to convey information to the computer system 104. The information is conveyed to the computer 140 without some or all embedded electronics or instrumentation and instead can employ cameras 142 and or a camera system 150 having audio/visual equipment to capture user interactions with the 3D printed object 144 and interpret those interactions to generate corresponding actions or outputs.

The cameras 142 can be positioned to view the 3D printed object from multiple angles. The computer system 104 processes the camera images to detect and interpret user interactions with specific features 164 of the 3D printed object. This interpretation may use a digital twin model of the object to precisely map interactions to specific locations. The system 160 can be trained using either an instrumented version of the object 144 or by associating camera-captured interactions with known desired outputs. Once trained, it can interpret interactions with a non-instrumented 3D printed version (object 144) to generate equivalent outputs or actions.

For example, among the features 164 the 3D printed object 144 can include a keyboard portion, a piano key portion, knobs, buttons, etc. The 3D printed keyboard could be used to input text or commands by interpreting movements of hands 166 over the features and finger presses on specific keys or features 164. In another example, a 3D printed map could trigger information displays when specific regions are touched. The system 160 permits the creation of interactive 3D printed objects without the complexity and cost of embedding electronics or other instruments.

Augmented Reality (AR) and Mixed Reality (MR) (AR/MR) are technologies that blend digital content with the physical world. In AR, digital information is overlaid onto the real environment. MR goes further by allowing digital objects to interact with the physical environment in real-time. AR/MR may be used to enhance the interaction with the 3D printed object 144. For example, the system 160 may project virtual buttons 168 or interfaces onto the 3D printed object 144, allowing for more complex interactions without the need for embedded electronics. The camera system 150 used to capture user interactions may also serve as an AR/MR display system, providing visual feedback or additional information to the user.

The system 160 can modify blueprints 114 to optimize 3D printed objects for AR/MR applications. This may involve adding specific textures or markers that are easily recognizable by AR/MR systems or designing the object's shape to better accommodate virtual overlays. The system 160 may also use AR/MR to guide users through the interaction process, highlighting active areas or providing visual cues for gestures.

In an embodiment, a user can access a 3D printer and a video device ecosystem. The user can designate an item that they would like to 3D print from a database or collective knowledge corpus 120 (FIG. 1) (e.g., a limited corpus of known adaptable blueprints 114). The item selected can include a simpler version of the blueprints without electrical components or instrumentation needed. The item may include moveable features that can add a degree of movement as designated to enhance detectability, e.g., depressible keys on a keypad.

The video device ecosystem can include high fidelity cameras to capture user interactions on 3D printed object or a non- 3D printed version in a learning/training mode to integrate with a known corpus of user interaction and device relationships or integrate with a manual of known bindings and interactions such as from a manual. The 3D printer can print an artifact with a degree of movement to enhance detectability by a camera, array of cameras, or other visual/audio detection devices.

A controllable device 170 (or devices) can be used to carry out the output actions generated based on the interpreted interactions with the 3D printed object. These controllable devices 170 may include, e.g., robotic arms or manipulators that can perform physical actions in response to the interpreted gestures or interactions. For example, a robotic arm may move, grasp, or manipulate objects based on the user's interactions with the 3D printed object 144. In another embodiment, the controllable device 170 can include smart home devices such as lights, thermostats, or door locks that can be controlled based on the interpreted interactions. For example, touching a specific area of a 3D printed control panel may trigger the adjustment of room temperature or lighting. In another embodiment, the controllable device 170 can include computer peripherals like printers, scanners, or external displays that can be activated or controlled through interactions with the 3D printed object 144. For example, a 3D printed keyboard may initiate printing or scanning operations. In another embodiment, the controllable device 170 can include audio systems or speakers that can adjust volume, change tracks, or modify audio settings based on user interactions with a 3D printed controller.

In another embodiment, the controllable device 170 can include virtual or augmented reality systems that can modify the displayed content or environment based on user interactions with physical 3D printed objects. In another embodiment, the controllable device 170 can include medical devices or assistive technologies that can be adjusted or activated through interactions with specially designed 3D printed interfaces. In another embodiment, the controllable device 170 can include educational or training simulators that respond to user interactions with 3D printed models or controls, providing feedback or changing scenarios accordingly. In another embodiment, the controllable device 170 can include entertainment systems, such as gaming consoles or interactive displays, which can be controlled through gestures or interactions with 3D printed game controllers or interfaces.

The controllable device 170 may be connected to the computer system 104 through various connection types, such as Wi-Fi, Bluetooth™, or other wireless protocols, or through wired connections. The computer system 104 may include appropriate software and hardware interfaces to translate the interpreted interactions into specific commands or actions for each type of controllable device 170.

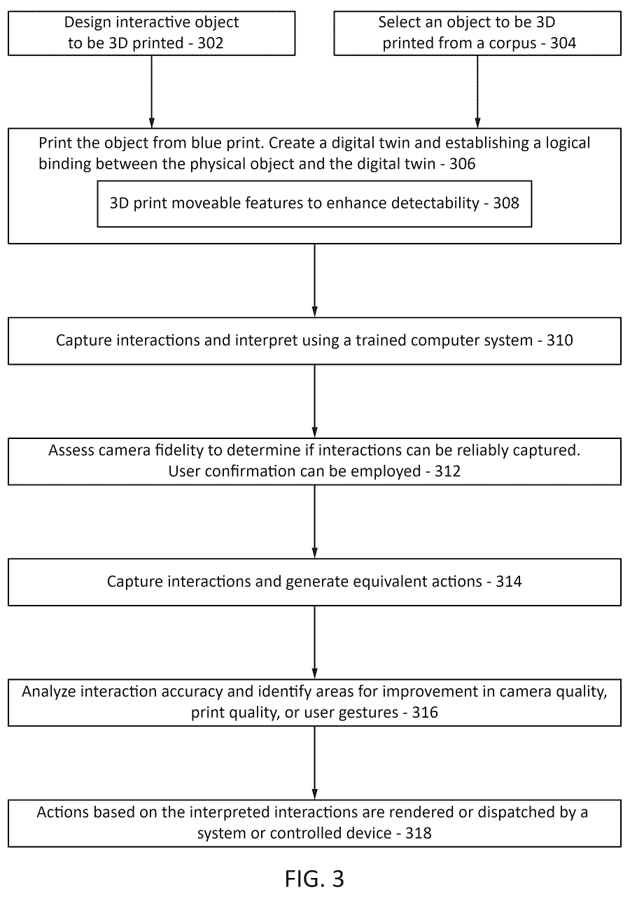

Referring to FIG. 3, a flow diagram describes use scenarios in accordance with embodiments of the present invention. In block 302, a user designs an interactive object to be printed on a 3D printer that can be employed with a video device ecosystem (e.g., camera system 150 (FIG. 2)). Alternately, in block 304, the user selects an object to be 3D printed from a corpus of known adaptable blueprints. The corpus can include complex features having a simpler version of those features without electrical components. In some embodiments, the complex features can include a degree of movement designated to enhance detectability (of the camera system 150).

In block 306, the object is printed from a blueprint which can be employed to create a digital twin of the object. The 3D printed duplicate (object) is printed and a logical binding is established with the digital twin or other model and degrees of movement of their interactions, etc.

In block 308, the 3D printer can print movable features (with a binary movement (e.g., a switch) or a degree of movement (e.g., a slider of knob) to assist in detectability by a camera, array of cameras, or other visual/audio detection devices.

In block 310, the object is exposed to a camera environment where images are captured from interactions with the object. The images are supplied to a trained computer system that interprets the interactions. The trained computer system can be trained using previous gestures and associated actions as training data. In another embodiment, the trained computer system can be trained by using a non-3D printed version of the object with instrumentation. The response of the instrumentation is associated with the interactions to yield a result (actions). The machine learning can then recognize using interaction recognition using a precise physical model (the object) and the digital twin for interpretation. The machine learning can integrate a known corpus of user interactions and device relationships and/or integrate a manual of known bindings and interactions such as from a gesture manual.

In block 312, visual fidelity of the camera system is determined to assess whether interactions can be reliably captured. In some embodiments the user may be asked to bind, rebind, or confirm each feature or interaction with the 3D printed model to view the results.

The user interactions can be bound with each feature, gesture, etc. using an instrumented version of the object, if available for testing purposes. The cameras could capture the user's input/degree of movement at a certain reliability threshold, say, e.g., 80-90% confidence that the interaction resulted in the correct output action. Statistical significance can be based on the number of correct reads, incorrect reads, degree of significant movement, degree of capture of the interaction, user gestures and other measures.

In block 314, input interactions with the 3D printed object are captured and equivalent actions are generated/dispatched by an operating system (OS) level or application level agent embedded in the computer system.

In block 316, improvement in interaction accuracy can be correlated to a number of factors including camera fidelity and quality for capturing interactions, 3D print quality, etc. The system can identify problem areas when the expected actions do not match the user's intent/expectations. In such situations, the features on the 3D printed object can be modified for future prints, gestures can be enhanced by the user (or changed to something easier to read/capture). Camara quality can be improved by considering, e.g., camera angle, camera fidelity, camera type, etc. Future versions of the 3D printed object can be printed to ensure the highest fidelity of dispatched and video captured events.

In block 318, actions are rendered/dispatched by a system or controlled device. The equivalent action is generated as if it were generated by the more complex/electrical piece without embedding of instrumentation (e.g., electrical inputs and components).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

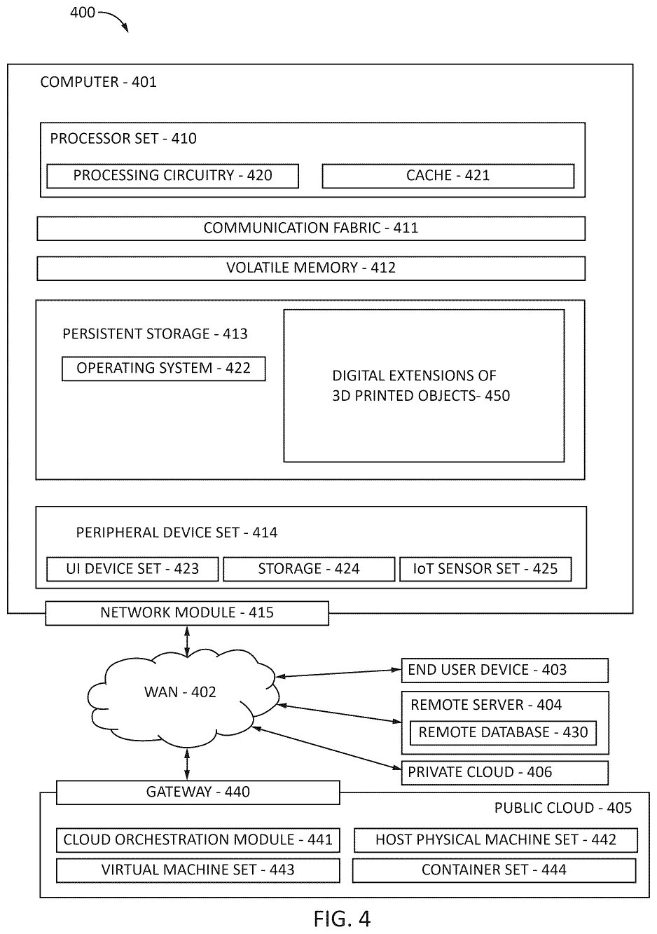

Referring to FIG. 4, a computing environment 400 contains an example of an environment for the execution of at least some of the computer code involved in performing the inventive methods 450, such as, systems and methods that enable 3D printed objects to be digitally extended and generate actions without instrumentation. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

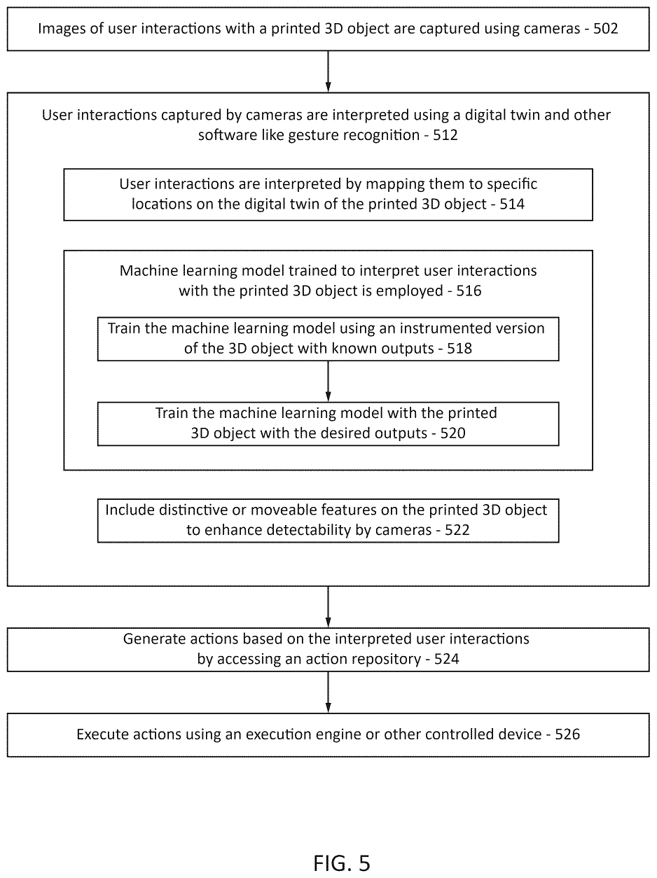

Referring to FIG. 5, a system/computer-implemented method is described for digitally extending a 3D printed object in accordance with embodiments of the present invention. In block 502, images are captured, using one or more cameras, of user interactions with a printed 3D object. The printed 3D object has a digital twin. The digital twin can be enhanced with other features but can include a copy of a digital blueprint of the 3D printed object.

In block 512, the user interactions captured by the one or more cameras are interpreted using the digital twin. Other forms of software can be employed to interpret the interactions. For example, gesture recognition software can be used. In block 514, the user interactions can be interpreted by mapping the user interactions to specific locations on the digital twin of the printed 3D object.

In block 516, a machine learning model can be trained to interpret the user interactions with the printed 3D object. In block 518, the machine learning model can be trained by capturing user interactions with an instrumented version of the printed 3D object and associating the captured user interactions with known outputs of the instrumented version of the printed 3D object. In block 520, the machine learning model can be trained by capturing user interactions with the printed 3D object and associating the captured user interactions with desired outputs. In block 522, the printed 3D object can include distinctive features and/or moveable features to enhance detectability by the one or more cameras.

In block 524, actions are generated based on the interpreted user interactions. The actions generated based on the interpreted user interactions can be assigned by accessing an action repository to determine actions corresponding to the user interactions. In block 526, actions can be executed using an execution engine or other controlled device.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
capturing, using one or more cameras, user interactions with a printed three-dimensional (3D) object, the printed 3D object having a digital twin;
interpreting the user interactions captured by the one or more cameras using the digital twin; and
generating actions based on the user interactions.

2. The computer-implemented method of claim 1, further comprising:
training a machine learning model to interpret the user interactions with the printed 3D object.

3. The computer-implemented method of claim 2, wherein training the machine learning model comprises:
capturing user interactions with an instrumented version of the printed 3D object; and
associating the user interactions with known outputs of the instrumented version of the printed 3D object.

4. The computer-implemented method of claim 1, wherein the printed 3D object includes moveable features to enhance detectability by the one or more cameras.

5. The computer-implemented method of claim 1, wherein interpreting the user interactions includes mapping the user interactions to specific locations on the digital twin of the printed 3D object.

6. The computer-implemented method of claim 1, wherein generating actions based on the user interactions includes accessing an action repository to determine actions corresponding to the user interactions.

7. The computer-implemented method of claim 6, further comprising:
executing the actions using an execution engine.

8. A computer system, comprising:
a processor set;
one or more computer-readable storage media; and
program instructions stored on the one or more computer-readable storage media to cause the processor set to perform operations comprising:
capturing, using one or more cameras, user interactions with a printed three-dimensional (3D) object, the printed 3D object having a digital twin;
interpreting the user interactions captured by the one or more cameras using the digital twin; and
generating actions based on the user interactions.

9. The computer system of claim 8, wherein the operations further comprise:
training a machine learning model to interpret the user interactions with the printed 3D object.

10. The computer system of claim 9, wherein training the machine learning model comprises:
capturing user interactions with an instrumented version of the printed 3D object; and
associating the user interactions with known outputs of the instrumented version of the printed 3D object.

11. The computer system of claim 8, wherein the printed 3D object includes moveable features to enhance detectability by the one or more cameras.

12. The computer system of claim 8, wherein interpreting the user interactions includes mapping the user interactions to specific locations on the digital twin of the printed 3D object.

13. The computer system of claim 8, wherein generating actions based on the user interactions includes accessing an action repository to determine actions corresponding to the user interactions.

14. The computer system of claim 13, wherein the operations further comprise:
executing the actions using an execution engine.

15. A computer program product, comprising:
one or more computer-readable storage media; and
program instructions stored on the one or more computer-readable storage media to perform operations comprising:
capturing, using one or more cameras, user interactions with a printed three-dimensional (3D) object, the printed 3D object having a digital twin;
interpreting the user interactions captured by the one or more cameras using the digital twin; and
generating actions based on the user interactions.

16. The computer program product of claim 15, wherein the operations further comprise:
training a machine learning model to interpret the user interactions with the printed 3D object.

17. The computer program product of claim 16, wherein training the machine learning model comprises:
capturing user interactions with an instrumented version of the printed 3D object; and
associating the user interactions with known outputs of the instrumented version of the printed 3D object.

18. The computer program product of claim 15, wherein the printed 3D object includes moveable features to enhance detectability by the one or more cameras.

19. The computer program product of claim 15, wherein interpreting the user interactions includes mapping the user interactions to specific locations on the digital twin of the printed 3D object.

20. The computer program product of claim 15, wherein generating actions based on the user interactions includes:
accessing an action repository to determine actions corresponding to the user interactions; and
executing the actions using an execution engine.
